(19) United States
(12) Patent Application Publication
(10) Pub. No.: US 2012/0256882 A1
(43) Pub. Date: Oct. 11, 2012

(54) TOUCH SURFACE WITH IDENTIFICATION OF REDUCED PERFORMANCE

(75) Inventors: Tomas Christiansson, Torna-Hallestad (SE); Christer Fåhraeus, Bjarred (SE); Ola Wassvik, Brosarp (SE)

(73) Assignee: FlatFrog Laboratories AB, Lund (SE)

(21) Appl. No.: 13/516,133

(22) PCT Filed: Dec. 20, 2010
(86) PCT No.: PCT/SE10/51420

§ 371 Date: Jun. 14, 2012

(30) Foreign Application Priority Data
Dec. 21, 2009 (SE) 0950997-7

(51) Int. Cl. G06F 3/042

(52) U.S. Cl. 345/175

(57) ABSTRACT

A device is configured to process data from a touch-sensitive apparatus for the purpose of identifying a reduced performance of components in the apparatus. The apparatus may be an FTIR system that comprises a light transmissive panel, an illumination arrangement for introducing light into the panel, and a light detection arrangement for receiving the light propagating in the panel and for measuring the energy of the received light. The device comprises a processor unit which is configured to obtain a signal comprising a time series of signal values that represent the energy of the light received by the light detection arrangement; calculate a parameter value representing a temporal variability of the signal values in the signal; and identify, based on the parameter value, a reduced performance of any of the illumination arrangement and the light detection arrangement. The temporal variability may be calculated to represent one of an absolute noise level and a signal-to-noise ratio of the signal, and enables the reduced performance to be identified while objects touch the light transmissive panel.

### CROSS-REFERENCE TO RELATED APPLICATIONS

The present application claims the benefit of Swedish patent application No. 0950997-7, filed on 21 Dec. 2009, and U.S. provisional application No. 61/288,416, filed on 21 Dec. 2009, both of which are incorporated herein by reference.

### TECHNICAL FIELD

The invention relates to touch-sensitive panels and data processing techniques in relation to such panels.

### BACKGROUND ART

To an increasing extent, touch-sensitive panels are being used for providing input data to computers, cell phones, electronic measurement and test equipment, gaming devices, etc. The panel may be provided with a graphical user interface (GUI) for a user to interact with using e.g. a pointer, stylus or one or more fingers. The GUI may be fixed or dynamic. A fixed GUI may e.g. be in the form of printed matter placed over, under or inside the panel. A dynamic GUI may be provided by a display screen integrated with, or placed underneath, the panel or by an image being projected onto the panel by a projector.

There are numerous known techniques for providing touch sensitivity to the panel for purpose of detecting interaction between a touching object and the panel, e.g. by using cameras to capture light scattered off the point(s) of touch on the panel, or by incorporating resistive wire grids, capacitive sensors, strain gauges, etc. into the panel.

U.S. Pat. No. 7,432,893 discloses an alternative technique which is based on frustrated total internal reflection (FTIR). Diverging beams from two spaced-apart light sources is coupled into a panel to propagate inside the panel by total internal reflection. The light from each light source is evenly distributed throughout the entire panel. Arrays of light sensors are located around the perimeter of the panel to detect the light from the light sources. When an object comes into contact with a surface of the panel, the light will be locally attenuated at the point of touch. The interaction between the object and the panel is determined by triangulation based on the attenuation of the light from each source at the array of light sensors.

U.S. Pat. No. 3,673,327 discloses a similar technique also using FTIR in which arrays of light beam transmitters are placed along two edges of a panel to set up a grid of intersecting light beams that propagate through the panel by internal reflection. Corresponding arrays of beam detectors are placed at the opposite edges of the panel. When an object touches a surface of the panel, the beams that intersect at the point of touch will be attenuated. The attenuated beams on the arrays of detectors directly identify the interaction between the object and the panel.

US2009/0153519 discloses another technique also using FTIR where a tomograph includes signal flow ports that are positioned at discrete locations around a border of a touch-panel. Signals are introduced into the panel to pass from each discrete panel-border location to a number of other discrete panel-border locations. The passed signals are tomographically processed to determine if any change occurred to the signals is caused by a touch on the panel during signal passage through the panel. From the tomographically processed signals any local area on the panel where a change occurred is determined. The tomograph thereafter computes and outputs a signal indicative of a panel touch and location.

The FTIR techniques described above are generally capable of identifying touches and appear to assume that various components of the respective panel operate as intended during this process. However, in case some components such as light emitters and light detectors degrade or fail, the panels would exhibit a gradual or even total loss of capability of accurately identifying touches.

U.S. Pat. No. 4,645,920 discloses a method of detecting faults in a so-called opto-matrix touch input device. In this device, light beams are propagated above a touch surface from a large number of different directions between emitters and detectors arranged around the periphery of the touch surface. An object that touches the touch surface will block certain light beams. By processing the output of the detectors, the system determines the location of the touching object. Further, detector readings of the received light from different emitters are compared to an ambient reading corresponding to the received light from the ambient light when no emitters are lighted. If the difference between the readings exceed a first or second threshold level, the corresponding beam is determined as a “bad beam” or a “marginal beam”, respectively, i.e. a defect status caused by a defect component in the touch apparatus.

This technique may be difficult to apply in an FTIR system, where the light is not blocked by the object but merely attenuated, e.g. in the range of 0.1-10% depending on the type of object and also on the motion pattern of the object on the touch surface. In an FTIR system, it may therefore be difficult to distinguish a signal decrease caused by a touch from a signal decrease caused by a degraded or defect component.

### SUMMARY

It is an object of the invention to at least partly overcome one or more limitations of the prior art. In particular, it is an object to enable touch determination to be performed in a touch-sensitive apparatus concurrently with detection of degradation or failure in components of the apparatus. In embodiments of the invention, it is also an object to provide a possibility to compensate for or handle the detected degradation.

A first aspect of the invention is a device for processing data from a touch-sensitive apparatus. The touch-sensitive apparatus comprises a light transmissive panel, an illumination arrangement for introducing light into the panel, a light detection arrangement for receiving the light propagating in the panel and for measuring the energy of the received light. The device comprises a processor unit configured to: obtain a signal comprising a time series of signal values that represent the energy of the light received by the light detection arrangement; calculate a parameter value representing a temporal variability of the signal values in the signal; and identify, based on the parameter value, a reduced performance of any of the illumination arrangement and the light detection arrangement.

The temporal variability, which is a measure of the momentary variations in the time series of signal values, is less affected by touches on the touch surface than the individual signal values. Thus, by using the temporal variability as a measure or parameter, it is possible to identify a reduced performance in an FTIR system even in the presence of one or more touches on the touch surface.

The temporal variability, which is also denoted “temporal change” herein, may be seen as a measure of a stochastic variability in the signal. The stochastic variability may infer that the signal values vary around a local average in the signal. The temporal variability may also be seen as a noise characteristic or noise-related feature of the signal. For example, the parameter value may be calculated to represent one of an absolute noise level and a signal-to-noise ratio (SNR) of the signal.

Thus, in the first aspect of the invention, the reduced performance may basically be identified based on signal components that are considered as disturbances when the signal is processed for determining the location of touches on the touch surface.

Typically, the processor unit is configured to repeatedly calculate the parameter value based on the time series of signal values, to generate a sequence of parameter values. Each parameter value may be determined based on a set of recent signal values in the signal, i.e. one or more of the latest signal values obtained at each time instant.

In one embodiment, the parameter value is calculated to represent the temporal variability within a time window in the signal. The time window may correspond to a signal segment in the signal, i.e. a sequence of signal values.

The temporal variability may be calculated as a statistical dispersion measure of the signal values in the time window. The statistical dispersion measure may include at least one of: a standard deviation, a variance, a coefficient of variation, a sum of differences, an energy, a power, a sum of absolute deviations from an average value, and an average of absolute differences from an average value.

The length of the time window may be selected to represent a momentary or short-term variability in the signal.

In one embodiment, the processor unit is further configured to high-pass filter the signal, wherein the parameter value is calculated based on the high-pass filtered signal. The high-pass filtered signal may be obtained by applying a high-pass filter to the original signal, or by applying a low-pass filter to the original signal and subtracting the result from the original signal. In either variant, the resulting high-pass filtered signal may represent the temporal variability of the original signal. In such an embodiment, where the individual signal values in the high-pass filtered signal may be seen to represent the temporal variability, the parameter value may be given by a current signal value in the high-pass filtered signal. Alternatively, the parameter value may be calculated for the signal values within a time window in the high-pass filtered signal. For example, the parameter values may be calculated as an average of the signal values, or as any of the above-mentioned statistical dispersion measures.

In one embodiment, the processor unit is configured to, for identifying the reduced performance, compare the parameter value to a reference measure, wherein the reference measure is one of a range and a threshold. The reference measure may be predefined, or determined based on preceding signal values in the signal.

Obtaining or generating the signal that represents the energy of received light may be done in numerous suitable ways and may include any operation for processing measurement data from a light-detecting device. Typically, the signal reflects not only energy of light received by the light detection arrangement, but also noise that for some reason may be caused by a component of the apparatus. The signal must not necessarily be a measurement signal (raw signal) of the light detection arrangement but may be any signal derived there from, such as a normalized signal, and/or a processed signal representing the energy of the received light in one or more (e.g. two) dimensions of the touch surface.

In further detail, the signal may be a set of data describing e.g. a so-called attenuation in the panel, a transmission (T) of light through the panel, a logarithmic transmission (log(T)), an energy of received light, or any other signal value associated with the distribution of light in the panel. The signal may indicate locations where the light propagating in the panel is affected by an object touching the touch surface or by a contamination present on the touch surface.

The reduced performance may comprise a gradual lowering of light output from the illumination arrangement or a gradually decreased capability of detecting light by the light detection arrangement, and may comprise an increased noise level caused by any of the illumination arrangement and light detection arrangement. The reduced performance may also comprise complete breakdown of any of the illumination arrangement and the light detection arrangement or breakdown of only a part thereof, such as breakdown of a certain light emitter or light detector. Moreover, “reduced performance” may be interpreted as any reduction in the light emitting performance of the illumination arrangement and/or any reduction in the light detecting performance of the light detection arrangement, where the reduction typically is a deviation from a desired performance. Such a deviation may occur e.g. if some parts of the illumination arrangement or light detection arrangement is intended to be attached to the panel but comes loose. Examples of such parts include structures for coupling the light into or out of the panel.

The reduced performance may also originate from any other component in the apparatus that may affect (e.g. convert, amplify, transmit, convey) the signal.

The reduced performance may be identified by a given criterion being fulfilled, e.g. that the parameter value falls below or above a certain level, depending on how the parameter value and the given criterion are represented.

In one embodiment, the processor unit is configured to identify the reduced performance by comparing a current parameter value with one or more previous parameter values. The current parameter value and the previous parameter value(s) may obtained by performing similar calculations but at different points in time, where the previous parameter value is obtained further back in time than the current parameter value. However, the current parameter value must not necessarily be obtained at the current real time.

In one embodiment, the processor unit is configured to identify the reduced performance by comparing a current parameter value with a time average of preceding parameter values. This is a more specific version of comparing a current parameter value with a previous parameter value, since the time average represents plural previous parameter values (which may be mutually weighted).

In one embodiment, the processor unit is configured to identify the reduced performance as a function a noise characteristic of the time series of signal values. The noise characteristic may comprise the level of thermal noise or shot noise, which is often inherent to the apparatus but which tend to increase when a component performs less well. The noise level may comprise other types of noise that often is affected by defects in components of the apparatus, such as flicker noise and burst noise, as well as ambient electromagnetic interference.

The noise level per se may be obtained by implementing conventional noise-measuring techniques performed on the signal. Such techniques commonly determine noise on basis of signal values obtained at different points in time. The noise may then be compared to a reference measure, and stochastic properties of the noise such as variance, distribution and spectral density may be determined and used in the comparison.

In one embodiment, the processor unit is configured to identify the reduced performance in response to an operator-triggered event. Optionally or in addition, the processor unit may be configured to regularly, i.e. at certain time intervals, evaluate if there is a reduced performance. An example of an operator-triggered event may be a function test, and an example of a certain time interval may be every 10:th second, once every hour, day or week, once every time the apparatus is started, etc. To save processing capacity and/or energy, the reduced performance may be determined less frequently than the location of touches (see below).

In one embodiment, the processor unit is configured to, if the reduced performance is identified, generate a signal calling for a certain operator activity, such as calling for maintenance, cleaning of the touch surface, replacement of a certain component, etc.

In one embodiment, the processor unit is configured to, if the reduced performance is identified, generate a signal for increasing the energy of light emitted from a certain emitter of the illumination arrangement, the certain emitter being associated with the reduced performance. This provides for an efficient way of compensating for the reduced performance, in particular if the reduced performance is caused by a gradual loss in efficiency of an emitter.

In one embodiment, the processor unit is configured to determine, when an object touches the touch surface and thereby attenuates the light propagating in the panel, a location of the object on the touch surface as a function of the signal. The location of the object on the touch surface may be defined by the position of the object (touch), by the shape and/or by the extension of the touch across the touch surface.

The touch-sensitive apparatus may operate by propagating light by internal reflection between the touch surface and an opposite surface, e.g. by way of total internal reflection, such that the touching object causes the propagating light to be attenuated at least partly by FTIR. It should be noted that there are several suitable techniques for introducing the light into the panel as well as for receiving the light, which includes a possibility to introduce and receive the light at a number of different light incoupling sites and light outcoupling sites at e.g. an edge of the panel or at an upper or at a lower surface of the panel. Typically, as long as the apparatus is in an operative mode, the light is continuously or intermittently introduced by the illumination arrangement while the light detection arrangement continuously or intermittently receives the light and generates measurement data. The processor unit may be configured to, in real time, obtain the signal, calculate the parameter value, identify the reduced performance, and determine the location. As further explained below, the processor unit may be configured to employ any of numerous known techniques for determining the location, such as triangulation-based techniques, tomography-based techniques, etc., using a raw signal of the light detection arrangement or a signal derived there from as input.

The determining of the location may be performed independently of the identifying of a reduced performance, even though it is possible to take the reduced performance into account when determining the location. In any case, the device may be capable of determining touch locations while simultaneously detecting degradation or failure of components of the apparatus, which may be advantageous in that a possibility to handle any effects of the degradation is provided.

As noted above, the device may be particularly suitable for use with an FTIR system, since the relatively complex signals that reflect the attenuation may be efficiently processed. In particular, the device has been found surprisingly promising in respect of efficiently determining the location while still employing comparatively simple and efficient data processing for identifying performance degradations.

In one embodiment, the processor unit is configured to, if the reduced performance is identified, disregard light emitted from a certain emitter of the illumination arrangement when determining the location, the certain emitter being associated with the reduced performance. This may be particularly advantageous if the certain emitter affects the signal to such an extent that the processor unit may fail in accurately determining the location.

In one embodiment, the processor unit is configured to, if the reduced performance is identified, disregard light detected by a certain detector of the light detection arrangement when determining the location, the certain detector being associated with the reduced performance. In a manner corresponding to the disregarding of light of a certain emitter, this may be particularly advantageous if the certain detector affects the signal such that the processor unit may fail in accurately determining the location.

In one embodiment, the processor unit is configured to determine the location by comparing the signal values in the signal to at least one touch threshold value, wherein the processor unit is configured to update the at least one touch threshold value as a function of the reduced performance. The updated touch threshold value may then be used for determining the location, for example by interpreting a change in the signal as originating from a touch on the touch surface when the signal passes (is above or below) the updated touch threshold value. The touch threshold values may e.g. be updated so as to avoid signal variations due to noise (caused by a reduced performance) being interpreted as a touch, for example by setting the touch threshold value slightly higher than the highest measured noise value.

In one embodiment, the processor unit is configured to calculate the parameter value for a set of sub-signals in the signal, wherein each sub-signal corresponds to a respective detection line extending between an emitter of the illumination arrangement and a detector of the light detection arrangement. Each sub-signal may comprise a time series of signal values that represent the energy of light received by an emitter on the respective detection line.

In one embodiment, the processor unit is configured to calculate the parameter value for each of a set of sub-signals in the signal, wherein each sub-signal corresponds to a respective detection line extending between an emitter of the illumination arrangement and a detector of the light detection arrangement. Thereby, the processor unit is operable to identify a reduced performance as a function of the temporal variability in the signal values of the different sub-signals. Thus, the reduced performance may be identified for a certain detection line, based on the parameter value calculated for a part (sub-signal) of the signal associated with the certain detection line(s).

In one embodiment, the processor unit is configured to, if the reduced performance is identified for a certain detection line, disregard signal values associated with the certain detection line when determining the location. Optionally or additionally, the processor unit may be configured to, if the reduced performance is identified for a certain detection line, cause the signal values that are associated with the certain detection line to be filtered for suppression of noise, before or when determining the location.

In one embodiment, the processor unit is configured to compare the signal values of each sub-signal to a respective touch threshold value, wherein the processor unit is configured to update the touch threshold values as a function of the reduced performance. The touch threshold values for detection lines may here be determined, modified and employed in a manner similar with the previously discussed touch threshold value for the signal.

In one embodiment, the processor unit is configured to determine which of an emitter of the illumination arrangement and a detector of the light detection arrangement that causes the reduced performance, based on the parameter values calculated for a number of detection lines.

A second aspect of the invention is a device for processing data from a touch-sensitive apparatus. The touch-sensitive apparatus comprises a light transmissive panel, an illumination arrangement for introducing light into the panel, a light detection arrangement for receiving the light propagating in the panel and for measuring the energy of the received light. The device comprises: means for obtaining a signal comprising a time series of signal values that represent the energy of the light received by the light detection arrangement; means for calculating a parameter value representing a temporal variability of the signal values in the signal; and means for identifying, based on the parameter value, a reduced performance of any of the illumination arrangement and the light detection arrangement.

Embodiments of the second aspect of the invention may correspond to the above-identified embodiments of the first aspect of the invention.

It should be noted that one or more of the means in the device according to the second aspect, including its various embodiments, may be implemented in either hardware or software, or a combination thereof.

A third aspect of the invention is an apparatus for determining a location of at least one object on a touch surface. The apparatus comprises: a light transmissive panel defining the touch surface and an opposite surface; an illumination arrangement configured to introduce light into the panel for propagation by internal reflection between the touch surface and the opposite surface; a light detection arrangement configured to receive the light propagating in the panel and measure the energy of the received light; and a device according to any of the first and second aspects.

A fourth aspect of the invention is a method for operating a touch-sensitive apparatus. The touch-sensitive apparatus comprises a light transmissive panel, an illumination arrangement for introducing light into the panel, a light detection arrangement for receiving the light after propagation in the panel. The method comprises: operating the illumination arrangement to introduce light into the panel for propagation by internal reflection between a touch surface and an opposite surface of the panel; operating the light detection arrangement to measure the energy of the received light; obtaining a signal comprising a time series of signal values that represent the energy of the light received by the light detection arrangement; calculating a parameter value representing a temporal variability of the signal values in the signal; and identifying, based on the parameter value, a reduced performance of any of the illumination arrangement and the light detection arrangement.

A fifth aspect of the invention is a method for processing data from a touch-sensitive apparatus. The touch-sensitive apparatus comprises a light transmissive panel, an illumination arrangement for introducing light into the panel, a light detection arrangement for receiving the light propagating in the panel and measuring the energy of the received light. The method comprises: obtaining a signal comprising a time series of signal values that represent the energy of the light received by the light detection arrangement; calculating a parameter value representing a temporal variability of the signal values in the signal; and identifying, based on the parameter value, a reduced performance of any of the illumination arrangement and the light detection arrangement.

The inventive methods may include any of the functionality implemented by the features described above in association with the inventive devices and share the corresponding advantages. For example, the method may include a number of steps corresponding to the above described operations of the processor unit.

A sixth aspect of the invention is a computer-readable medium is provided, which stores processing instructions that, when executed by a processor, performs the method according to the fourth or fifth aspect.

Still other objectives, features, aspects and advantages of the invention will appear from the following detailed description, from the attached claims as well as from the drawings.

### BRIEF DESCRIPTION OF THE DRAWINGS

Embodiments of the invention will now be described, by way of example, with reference to the accompanying schematic drawings, in which

FIG. 1 is a top plan view of an embodiment of a touch-sensing apparatus for determining a location of at least one object on a touch surface,

FIG. 2 is a cross sectional view of the apparatus in FIG. 1,

FIG. 3 is a top plan view of the embodiment of the apparatus in FIG. 1, where propagation of light is illustrated in further detail,

FIG. 4 is a flow diagram of an embodiment of a method for identifying a reduced performance of the apparatus in FIG. 1, in combination with a method for determining a location of at least one object on a touch surface of the apparatus,

FIG. 5 illustrates a time distribution of a signal that represents the energy of light received by a light detection arrangement of the apparatus in FIG. 1,

FIG. 6 illustrates a time distribution of estimated noise in the signal of FIG. 5,

FIG. 7 illustrates a time distribution of a signal corresponding to the signal in FIG. 5, but measured for a defect component of the apparatus,

FIG. 8 illustrates a time distribution of estimated noise in the signal of FIG. 7,

FIG. 9 illustrates a threshold level used for determining the location of an object on a touch surface of the apparatus in FIG. 1,

FIG. 10 illustrates a threshold level used for determining a location of an object on a touch surface of the apparatus in FIG. 1 when a component of the apparatus is defect, and

FIG. 11 is a flow diagram of an embodiment of a method for determining a reduced performance of the apparatus in FIG. 1.

### DETAILED DESCRIPTION OF EXAMPLE EMBODIMENTS

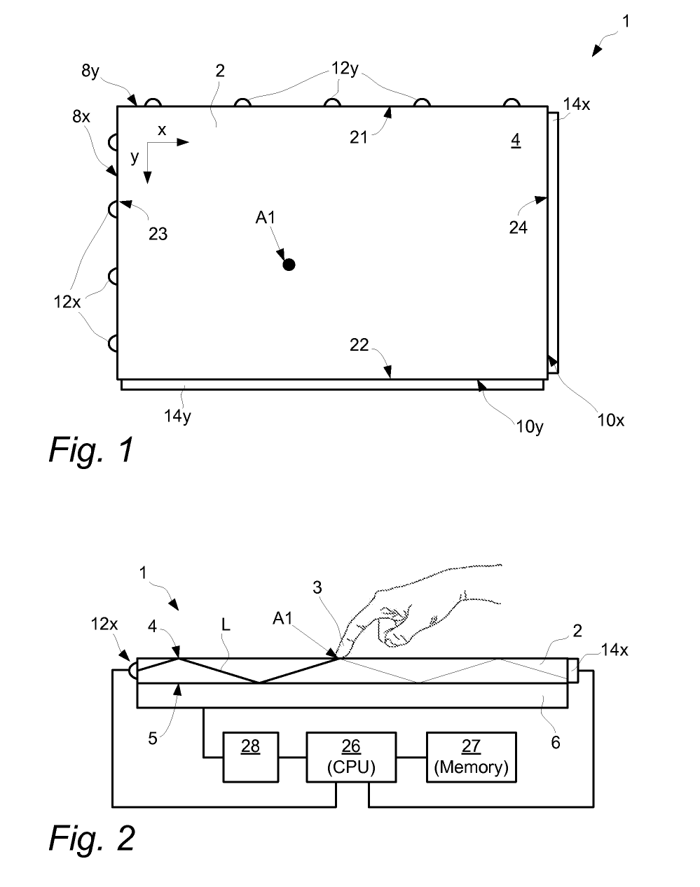

FIGS. 1 and 2 illustrate an embodiment of touch-sensing apparatus 1 for determining a location A1 of an object 3 that touches a touch surface 4. The touch-sensing apparatus 1 includes a light transmissive panel 2 that may be planar or curved. The panel 2 defines the touch surface 4 and an opposite surface 5 opposite and generally parallel with the touch surface 4. The panel 2 is configured to allow light L to propagate inside the panel 2 by internal reflection between the touch surface 4 and the opposite surface 5.

In FIG. 1, a Cartesian coordinate system has been introduced, with the x-axis being parallel to a first side 21 and to a second side 22 of the panel 2 while the y-axis is parallel to a third side 23 and to a fourth side 24 of the panel 2. The exemplified panel 2 has a rectangular shape but may just as well be e.g. circular, elliptical, triangular or polygonal, and another coordinate system such as a polar, elliptic or parabolic coordinate system may be used for describing the location A1 and various directions in the panel 2.

Generally, the panel 2 may be made of any material that transmits a sufficient amount of light in the relevant wavelength range to permit a sensible measurement of transmitted energy. Such material includes glass and polycarbonates. The panel 2 is typically defined by a circumferential edge portion such as by the sides 21-24, which may or may not be perpendicular to the top and bottom surfaces 4, 5.

The light L may be coupled into the panel 2 via one or more incoupling sites on the panel 2. For example, the light L may be coupled into (be introduced into) the panel 2 via a first incoupling site 8x at the third side 23 of the panel 2 and via a second incoupling site 8y at the first side 21 of the panel 2.

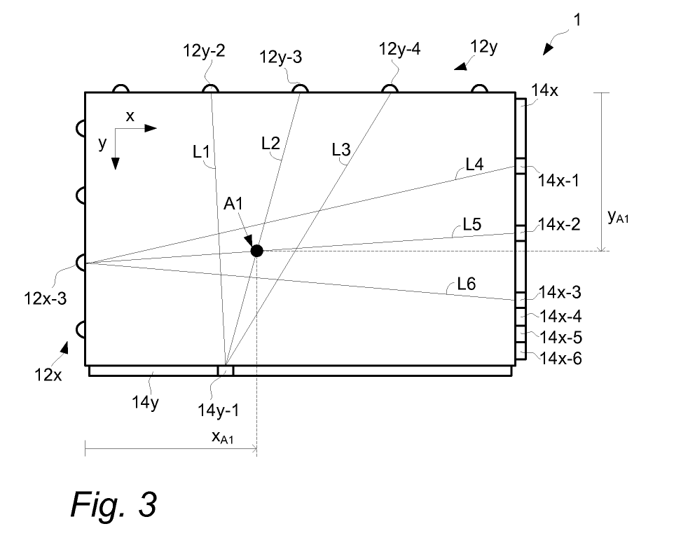

With further reference to FIG. 3, a first part 12x of an illumination arrangement is arranged at the first incoupling site 8x and a second part 12y of the illumination arrangement is arranged at the second incoupling site 8y. Each of the parts 12x, 12y comprises a number of light emitters such as light emitter 12x-3 of the first part 12x of the illumination arrangement and light emitters 12y-2, 12y-3, 12y-4 of the second part 12y of the illumination arrangement. In combination, the parts 12x, 12y may be seen as forming one illumination arrangement 12x, 12y.

The light emitters 12x-3, 12y-2, 12y-3, 12y-4 introduce light in form of a respective diverging beam (diverging in a plane of the panel 2) that propagates in a direction towards at least one of a first outcoupling site 10x at the fourth side 24 of the panel 2 and a second outcoupling site 10y at the second side 22 of the panel 2 where the light is received (coupled out). A first part of a light detection arrangement 14x is arranged at the first outcoupling site 10x and a second part of a light detection arrangement 14y is arranged at the second outcoupling site 10y, and may each measure the energy of the light received at the respective outcoupling site 10x, 10y. The parts 14x, 14y of the light detection arrangement may be seen as one light detection arrangement 14x, 14y.

The light emitters may be any type of device capable of emitting light in a desired wavelength range, for example a diode laser, a VCSEL (vertical-cavity surface-emitting laser), or alternatively an LED (light-emitting diode), an incandescent lamp, a halogen lamp, etc.

Each of the parts 14x, 14y of the light detection arrangement comprises a number of light detectors arranged in sequence, such as light detectors 14x-1 to 14x-6 of the first part 14x and light detector 14y-1 of the second part 14y. Although not illustrated, the light detection arrangement 14x, 14y comprises light detectors that cover the full length of the outcoupling sites 10x, 10y, which basically corresponds to the full lengths of the fourth side 24 and the second side 22. This may mean that light detectors are arranged adjacent each other, such as the illustrated light detectors 14x-3 to 14x-6.

The light detectors may be any type of device capable of detecting the energy of light emitted by the illumination arrangement 12x, 12y, such as a photodetector, an optical detector, a photoresistor, a photovoltaic cell, a photodiode, a reverse-biased LED acting as photodiode, a charge-coupled device (CCD) etc.

The light in the form of a diverging beam emitted from the light emitters 12x-3, 12y-2, 12y-3, 12y-4 is received by a certain number of light detectors of the first part 14x of the light detection arrangement and/or the second part 14y of the light detection arrangement. Exactly which of the light detectors that receives light from a certain light emitter depends on the location of the detectors and emitters and on the beam divergence (angular measurement) of the emitted light. For example, as illustrated by paths of light L1-L6, light emitted from each of the light emitters 12y-2, 12y-3, 12y-4 may propagate towards and be received by the light detector 14y-1, while light emitted from the light emitter 12x-3 may propagate towards and be received by each of the light detectors 14x-1, 14x-2, 14x-3.

Of course, depending on beam divergence and on the location of the emitters and detectors, light may pass between other sets of emitters/detectors, even though this is not illustrated.

Each of the light emitters may emit multiplexed light, for example by using wavelength-division multiplexing or pulse-code multiplexing, such that it is possible to identify unique paths of light from a certain light emitter to a certain light detector. For example, if wavelength-division multiplexing is used, light emitter 12x-3 may emit light with a wavelength of λx-3, light emitter 12y-2 may emit light with a wavelength of λy-2, light emitter 12y-3 may emit light with a wavelength of λy-3 and light emitter 12y-4 may emit light with a wavelength of λy-4. Each of the light detectors 14x-1, 14x-2, 14x-3 and 14y-1 may detect and differentiate light at different wavelengths and may generate a signal representing the energy of the received light for a certain wavelength. In this case, any suitable known type of light emitters and light detectors capable of emitting respectively detecting light at a certain wavelength may be used. However, the wavelengths are advantageously within the infrared or visible wavelength region.

Since the light detectors are capable of detecting and differentiating light having different wavelengths, e.g. the exemplified and illustrated paths of light L1-L6 may be determined.

In this context, a path of light may be referred to as a detection line, where, using FIG. 3 as an example, each detection line L1-L6 comprises a respective (unique) path of light from an emitter to a detector.

A signal S representing the energy of light received and measured by the light detection arrangement 14x, 14y is continuously provided to a processor unit (CPU) 26. More specifically, in the exemplified embodiment, the signal S may include a number of sub-signals S_{L1}, S_{L2}, S_{L3}, S_{L4}, S_{L5}, S_{L6}, where each sub-signal represents the energy of light emitted by a certain light emitter and received by a certain light detector, such that the sub-signals S_{L1}-S_{L6} correspond to a respective, unique detection line of the detection lines L1-L6. The signal S may thus be seen as an aggregation of the sub-signals S_{L1}-S_{L6}. It should also be noted that operations on the signal S described below may be performed on one or more of the sub-signals S_{L1}-S_{L6} of the signal S as well as directly on the (aggregated) signal S.

In this context, the aggregated signal S comprises e.g. the sum of the sub-signals S_{L1}-S_{L6}, where the sub-signals S_{L1}-S_{L6} typically are measured over the same period of time. The sub-signals S_{L1}-S_{L6} may also be processed and combined in other ways for forming the aggregated signal S, for example such that the signal S represents the two-dimensional distribution of light in the panel 2.

For receiving the signal(s) S, S_{L1}-S_{L6}, the processor unit 26 is connected to the light detection arrangement 14x, 14y such that the signal/sub-signals may be retrieved by the processor unit 26. Also, the processor unit 26 is connected to the illumination arrangement 12x, 12y for initiating and controlling the introduction of light in the panel 2.

As mentioned, the light L is allowed to propagate inside the panel 2 by internal reflection between the touch surface 4 and the opposite surface 5. As is known within the field of touch-sensitive panels, the internal reflection is typically caused by total internal reflection (TIR) which is sustained as long as the light L is injected into the panel at an angle to the normal of the panel which is larger than the critical angle at a light-injection site of the panel.

When the propagating light L impinges on the touch surface 4, the touch surface 4 allows the light L to interact with the touching object 3, and at the location A1 of the touch, part of the light L may be scattered by the object 3, part of the light L may be absorbed by the object 3 and part of the light L may continue to propagate by internal reflection. The scattering and the absorption of light are in combination referred to as attenuation. The touch between the touching object 3 and the touch surface 4 is typically defined by the area of contact between the object 3 and the touch surface 4, and results in the mentioned interaction between the object 3 and the propagating light L. The interaction between the object 3 and the light L generally involves so-called frustrated total internal reflection (FTIR), in which energy of the light L is dissipated into the object 3 from an evanescent wave formed by the propagating light L, provided that the object 3 has a higher refractive index than the material surrounding the touch surface 4 and is placed within less than several wavelengths distance from the touch surface 4.

More specifically, light propagating along a certain detection line is attenuated when the object 3 touches the touch surface 4. For example, for the detection lines of FIG. 3, light propagating along detection lines L2 and L5 is attenuated when the location A1 of the object 3 is positioned as illustrated. This means that the energy of light received by the light detector 14y-1 and being emitted by light emitter 12y-3 is reduced due to the attenuation. In a similar manner, the energy of light emitted by light emitter 12x-3 and received by the light detector 14x-2 is also reduced due to the attenuation.

From this follows that, when light along detection lines L2 and L5 is attenuated, the sub-signals S_{L2} and S_{L5} associated with attenuation lines L2 and L5 exhibit changes in signal levels. Since the sub-signals S_{L2} and S_{L5} represent the energy of light along detection lines L2 and L5, the signal levels of sub-signals S_{L2}, S_{L5} is typically reduced when attenuation occurs along the detection lines L2, L5.

Thus, by monitoring the signal levels of the sub-signals it is possible to determine for which detection lines light is attenuated; if the signal level of a sub-signal decreases to certain extent, the processor unit 26 may determine that an object is located somewhere along the detection line associated with the relevant sub-signal. Exactly how much the signal level must change for indicating a touch depends on the various components used in the apparatus and may be empirically determined.

By identifying detection lines affected by a touch, the x-coordinate x_{A1} and the y-coordinate y_{A1} of the location A1 may be determined by employing a standard tomography technique such as filtered back projection or by using common triangulation-based techniques. Such techniques typically take the sub-signals as input and use these in combination with knowledge about the location of each emitter and detector along the x-axis/y-axis.

It should be noted that in the exemplified embodiment, the distance between light detectors is preferably smaller than a typical extension of a touch, such that no touch may be located on a position on the touch surface that is not covered by a detection line.

For the described apparatus 1, a reduced performance of any of the illumination arrangement 12x, 12y and the light detection arrangement 14x, 14y may be identified on basis of the signal S and/or on basis of the sub-signals S_{L1}-S_{L6}. The reduced performance is often related to any of a light emitter, light detector, light incoupling structure and light outcoupling structure of the illumination arrangement 12x, 12y and/or the light detection arrangement 14x, 14y. The determination of the reduced performance is typically implemented by a method (i.e. in a method for identifying a reduced performance) that may be executed by the processor unit 26. The method for identifying a reduced performance is described in detail below and uses signals like the signal S and/or sub-signals S_{L1}-S_{L6} as input.

A number of alterative techniques exist for which the method for identifying a reduced performance may be used. For the purpose of exemplifying such alternative techniques and techniques that describe incoupling and outcoupling structures that may be used in the apparatus of FIG. 1, patent publications U.S. Pat. No. 6,972,753, U.S. Pat. No. 7,432,893, US2006/0114237, US2007/0075648, WO2009/048365, WO2010/006882, WO2010/006884, WO2010/006885, WO2010/006886, WO2010/064983 and WO02010/134865 are incorporated by reference.

For example, the method for identifying a reduced performance may be used in combination with the techniques disclosed in WO02010/064983. By adopting the apparatus 1 to the techniques of this document, an alternative apparatus (herein referred to as a “pulse coding apparatus”) may be achieved which would use pulse-code multiplexing for determining the detection lines, outputting related signal/sub-signals and determining the location of the object. In the pulse coding apparatus, light emitters are controlled to transmit a respective unique code by way of light emitted from each emitter, such that the code identifies the respective emitter. The processor unit may then process an output signal from the light detector(s) to separate the light received from the individual emitters based on the transmitted codes, and may thus determine a set of sub-signals corresponding to the sub-signals S_{L1}-S_{L6}. In principle, the alternative apparatus operates in a manner similar with the apparatus of FIG. 1, but with the difference that the light of the different detection lines is pulse-coded.

For providing another example, the method for identifying a reduced performance may be used in combination with the techniques disclosed in WO2010/006886. By adopting the apparatus 1 to the techniques of this document, a further alternative apparatus (herein referred to as a “scanning apparatus”) may be achieved which uses an input scanner arrangement to introduce beams of light into a panel, and sweeps the beams inside the panel across a sensing area. Light detectors are arranged to receive the beams from the input scanner arrangement while they are swept across the sensing area, and the data processor is connected to the light detector(s) and operated to identify touches on the touch surface based on an attenuation of the beams. In the scanning apparatus e.g. two light emitters and two light detectors may suffice for identifying the touches.

For the scanning apparatus, scan lines which enter and exit the panel at specific locations at the edge of the panel may be used as detection lines corresponding to the detection lines L1-L6 of FIG. 3. A sub-signal functionally similar with the sub-signals S_{L1}-S_{L6} may then be determined by obtaining the output signal of a detector the very moment in time when the location of the swept beam corresponds to the detection line. Thus, the temporal distribution of the swept beam across the panel in combination with the measurements of the sensor(s) will give signals corresponding to the sub-signals S_{L1}-S_{L6} of the apparatus 1 of FIG. 1.

For the scanning apparatus, a reduced performance may be related to a part of the incoupling and/or outcoupling structure (of the respective illumination arrangement and light detection arrangement) that is associated with a certain detection line. For example, if an outcoupling structure of the light detection arrangement that should be firmly attached to the panel has come loose, light measured at detection lines (scan beams coupled out) at a location of the loose parts may exhibit a different signal level.

Thus, considering the many alternatives that may be used in combination with the method for identifying a reduced performance, the light may be generated with different wavelengths for different emitters and detectors, but also as light with a uniform wavelength, for example if the apparatus uses pulse-code multiplexing for generating the detection lines or if the emitters in the illumination arrangement 12x, 12y are activated sequentially (one after the other).

Also, the alterative techniques illustrate numerous ways for coupling light into and coupling light out from the panel. This includes e.g. the possibility to couple the light into and out of the panel directly via any of the sides. Alternatively, a separate coupling element may be attached to the sides, to the touch surface or to the opposite surface of the panel to lead the light into or out of the panel. Such a coupling element may have the shape of e.g. a wedge. Also, the incoupling site may be only a small point at an edge or corner of the panel. Depending on the specific in/outcoupling technique used and on the type of apparatus, the light may be propagated in the panel as substantially straight beams, as diverging/converging/collimated beams, as coded beams using multiplexing etc. Moreover, the incoupling sites and the outcoupling sites may be arranged on common sides of the panel, depending on the specific in-outcoupling technique employed, such that incoupling and outcoupling sites are mixed along one or more edges of the panel.

The apparatus 1 may also include an interface device 6 for providing a graphical user interface (GUI) within at least part of the touch surface 4. The interface device 6 may be in the form of a substrate with a fixed image that is arranged over, under or within the panel 2. Alternatively, the interface device 6 may be a screen arranged underneath or inside the apparatus 1, or a projector arranged underneath or above the apparatus 1 to project an image onto the panel 2. Such an interface device 6 may provide a dynamic GUI, similar to the GUI provided by a computer screen. The interface device 6 is controlled by a GUI controller 28 that may determine where graphical objects of the GUI shall be located, for example by using coordinates corresponding to the coordinates for describing the interaction A1. The GUI controller 28 may be connected to and/or be implemented in the processor unit 26.

Turning now to the method for identifying, detecting or determining a reduced performance, an embodiment of this method will be described in a combination with a method for determining the location A1.

In the combination, by receiving the signal S for a period of time, the processor unit 26 may: i) evaluate a temporal variability in the signal S, ii) determine a reduced performance of any of the illumination arrangement and the light detection arrangement, based on the temporal variability, and iii) determine the location A1 as a function of the signal S. The combined method, which thus comprises a process for identifying a reduced performance and a process for determining the location, may be referred to as a “method for processing data from a touch-sensitive apparatus”. The signal S may comprise n number of sub-signals S_{L1}-S_{Ln} associated with n number of detection lines L1-Ln, e.g. the above exemplified sub-signals S_{L1}-S_{L6} and detection lines L1-L6.

Each of the combined method, the process for identifying a reduced performance and the process for determining the location may be implemented as processing instructions that are stored on a memory unit 27 (FIG. 2) connected to the processor unit 26 and which may be executed by the processor unit 26.

However, the process for identifying a reduced performance may be implemented in a separate device (comprising a processor unit and memory) which is adapted for connection to a touch-sensitive apparatus configured to detect an interaction between an object and a touch surface.

Also, a computer-readable medium arranged in a computer server may store processing instructions that, when executed by a processor, performs the method for identifying a reduced performance. In this case the processing instructions may be e.g. downloaded into a touch-sensitive apparatus for providing the functionality of identifying a reduced performance.

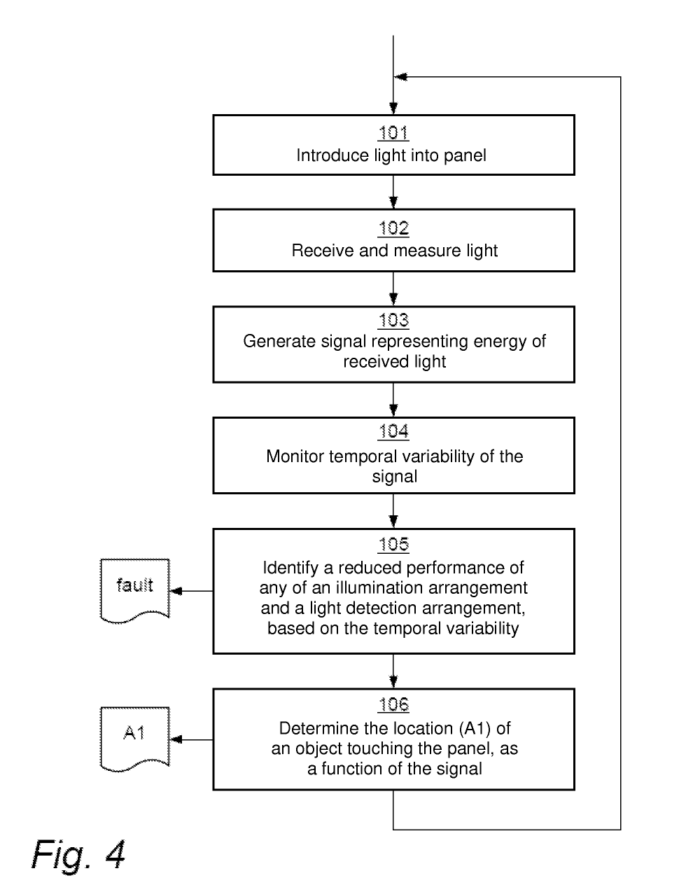

FIG. 4 is a flow diagram of an embodiment of the combined method.

The processor unit 26 implements the combined method by repeatedly performing a number of steps 101-106 which make use of the light introduced into the panel 2, propagated by internal reflection between the touch surface 4 and the opposite surface 5 and received by the light detection arrangement 14x, 14y. The method is iterative and the steps 101-106 may be carried out as long as the apparatus 1 is set in a mode for sensing touch interactions. Optionally, steps 104 and 105, which are further described below, are performed at regular time intervals or during certain conditions, such as every second, 20:th or 1000 iteration.

In further detail, in step 101 the light L is introduced into the panel 2 and in step 102 the introduced light is received. These steps 101, 102 may be performed by controlling the illumination arrangement 12x, 12y and the light detection arrangement 14x, 14y as described above.

In step 103, the signal S representing the energy of the light at the outcoupling sites 10x, 10y is generated. Optionally or additionally, n sub signals S_{L1}-S_{Ln} as described above are generated to each represent the energy of light for a respective detection line. Unless otherwise stated, subsequent operations on the signal S as described below may also be performed on one or more of the sub-signals S_{L1}-S_{Ln}.

More particularly, in step 103 the signal S may be generated by using the processor unit 26 for obtaining a raw signal of the light detection arrangement, or more specifically, for obtaining a raw signal of each light detector of the light detection arrangement during user interaction with the apparatus 1. The raw signal may be an unprocessed signal provided by the light detection arrangement, and may include sub-signals obtained by measuring light for different detection lines.

The raw signal(s) may be processed by e.g. normalizing the signal(s) with a corresponding reference signal. The reference signal(s) may be a signal generated in a manner similar to the generation of the raw signal(s), but at a certain moment in time when no object is present on the touch surface, such as when the assembly of the apparatus 1 is finalized or when a user initiates a reset operation of the apparatus 1. From this follows that each sub-signal may have a respective reference signal. Each reference signal is typically made available to the processor unit 26 by storing it in the memory unit 27.

If the signal(s) S, S_{L1}-S_{Ln} is set to the raw signal divided by the reference signal, the resulting signal(s) S, S_{L1}-S_{Ln} is a normalized signal that may represent a transmission T of light across the panel/along a detection line. Alternatively, if the signal(s) S, S_{L1}-S_{Ln} should represent attenuation it may be calculated as unity subtracted by the transmission (1-T). In another alternative, the signal(s) S, S_{L1}-S_{Ln} may be generated to represent logarithmic transmission, log (T).

More advanced techniques may be used for determining the signal(s) S, S_{L1}-S_{Ln}, which may include updating the reference signal before normalization. For purpose of exemplifying such other techniques, International patent applications No. PCT/SE2010/050932 and No. PCT/SE2010/051105 are incorporated by reference.

Accordingly, the signal(s) S, S_{L1}-S_{Ln} may hence be a raw signal or a normalized signal such as a transmission signal or an attenuation signal, and may represent e.g. the energy of light at a detection line L1-Ln or the energy of light across the panel in one or two dimensions.

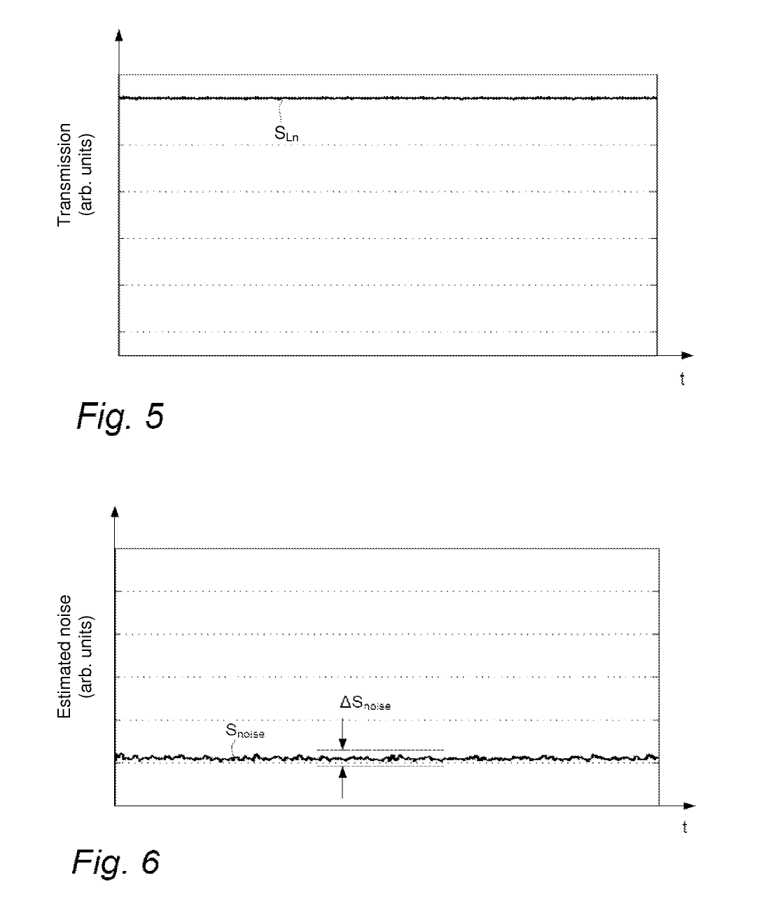

In step 104, the processor unit 26 monitors or estimates the temporal variability in the signal(s) S, S_{L1}-S_{Ln}. FIG. 5 illustrates a sub-signal S_{Ln} in the form of a transmission signal measured over time t. In the illustrated example, the signal level remains essentially constant over time since no touch interacts with (attenuates) the relevant detection line. It is also seen that the momentary temporal variability in the signal values is low, which is typical for a touch-sensing apparatus with properly functioning components.

The processor unit 26 may monitor the temporal variability by calculating a time series of parameter values based on the signal values in the signal S. For example, the parameter values may be given as a statistical dispersion measure of the signal values within a time window of the signal S. The statistical dispersion measure may be any measure that represents the variability or stochastic property of signal values within the time window. Non-limiting examples of potentially useful statistical dispersion measures include standard deviation (σ), variance (σ²), coefficient of variation (σ/μ) and variance-to-mean (σ²/μ). Other examples include a sum of differences, e.g. given by

$${\sum }_{i = 2}^{n} \vert {x}_{i} - {x}_{i - 1} \vert , or {\sum }_{i = 1}^{n} {\sum }_{j = 1}^{n} \vert {x}_{i} - {x}_{j} \vert ,$$

or an energy measure, such as

$${\sum }_{i = 1}^{n} {x}_{i}^{2} ,$$

with n being the number of signal values x in the signal segment defined by the time window. Yet other examples include a measure based on a sum of absolute differences from an average value m, with the average value m being calculated for the signal values in the signal segment using any suitable function, such as arithmetic mean, geometric mean, median, etc. Other examples include distribution measures and spectral density measures. It is to be noted that all of the above suggested dispersion measures also include normalized and/or weighted variants thereof.

It is to be understood that the temporal varibility of the signal values typically occurs on a different (much shorter) time scale than the signal changes caused by touches, and that the temporal variability is a persistent phenomenon in the signal (unless a light detector is broken, where the temporal variability may be essentially zero), whereas changes caused by touches are isolated events in the signal. The skilled person thus understands that the length of the time window may be optimized such that the resulting parameter value adequately captures the variability without being significantly affected by signal changes caused by touches. The influence of signal changes caused by touches may be additionally suppressed by designing the decision criterion of step 105 (see below) to require that a certain amount of parameter values fall outside a reference measure before a reduced performance is identified.

FIG. 6 illustrates a sequence of parameter values generated for the sub-signal S_{Ln} in FIG. 5, where each parameter value represents the variance in a small time window (having a length of a few seconds). The sequence of variance values may be regarded as an estimation of the noise in the sub-signal S_{Ln}, and are therefore denoted Sₙₒᵢₛₑ in FIG. 5. As seen, the noise signal Sₙₒᵢₛₑ is substantially constant over time.

The skilled persion readily realizes that there are alternative ways of estimating or isolating the noise in the signal S. Essentially any known noise processing technique may be employed, using the signal S as input. For example, the processor unit 26 may high-pass filter the signal S to substantially isolate one or more noise components in the signal S. The high-pass filtering may be direct or indirect, e.g. by low-pass filtering the signal S, and subtracting the low-pass filtered signal from the signal S.

The noise signal Sₙₒᵢₛₑ may, e.g., be generated to represent thermal noise, shot noise, flicker noise, burst noise and ambient electromagnetic interference, or any combination thereof.

Depending on implementation, the parameter value may be a single value output by such a noise processing technique, or an aggregation of several output values.

In a variant, the noise signal is given in terms of signal-to-noise ratio (SNR) which may be determined as the ratio of a signal measure and a noise measure, as is known in the art. The SNR may be extracted using any known signal processing technique, be it analog or digital, or a combination thereof. Reverting to the example of using time windows, the SNR may be given by the ratio of an average of the signal values in the time window to the statistical dispersion measure.

A low or insignificant noise level e.g. in form of a low absolute noise or noise variance has been identified as typical for a touch-sensing apparatus with properly functioning components. A suitable value for the noise interval ΔSₙₒᵢₛₑ may be empirically determined by investigating noise values or properties thereof for properly functioning respectively defect components.

Reverting to FIG. 6, it is to be understood that each parameter value is generated by step 104 in one iteration of steps 101-106, and thus the time window is formed by a set of the most recently obtained signal values in the sub-signal S_{Ln}. The time windows may be seen to “slide” along the signal for every iteration, where consecutive parameter values may be calculated for time windows that are partly overlapping, although it is also possible that the time windows are non-overlapping.

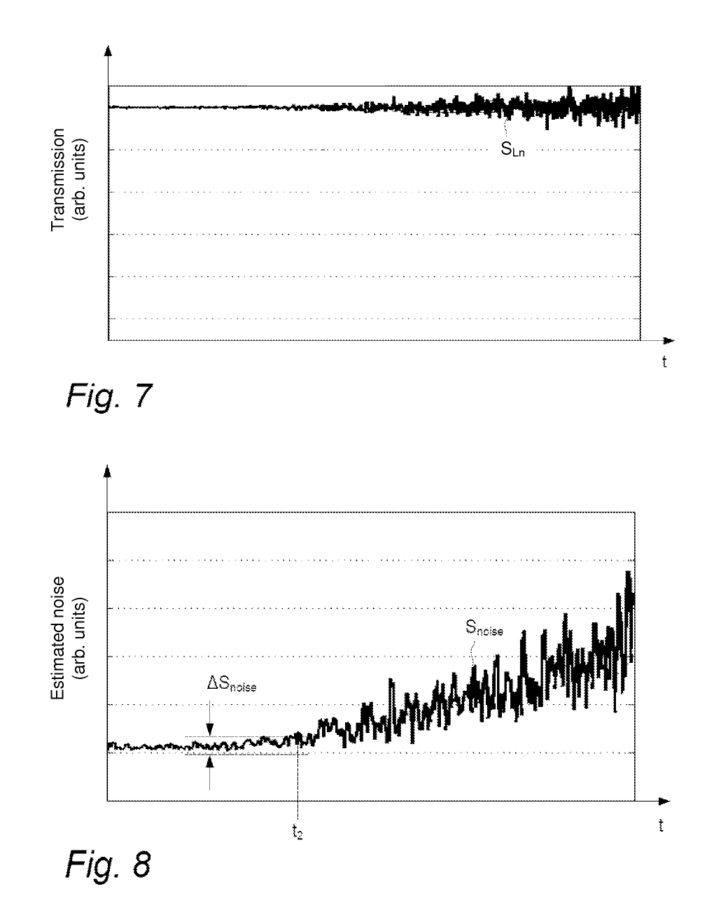

When components degrade or fail in the touch-sensitive apparatus, the temporal variability of the signal S will be significantly different. FIG. 7 illustrates a sub-signal S_{Ln} in the form of a transmission signal generated based on measurement data from a light detector that gradually loses its proper performance. FIG. 8 illustrates a noise signal Sₙₒᵢₛₑ, given as variance within time windows of the signal in FIG. 7. FIGS. 7 and 8 clearly illustrate that the temporal variability increases over time as the performance is gradually degraded.

FIG. 8 indicates that a dispersion measure indeed may be used as a parameter value for identifying a reduced performance. It is also seen in FIG. 8 that the values of the dispersion measure not only increase over time, but also that the temporal variability of the dispersion values increase over time. Thus, an alternative parameter value may be calculated as a statistical dispersion measure within a time window of the noise signal Sₙₒᵢₛₑ. Any of the above-mentioned statistical dispersion measures may be used.

In step 105, a reduced performance of any of the illumination arrangement 12x, 12y and the light detection arrangement 14x, 14y is identified as a function of the temporal variability in signal S, given by the parameter value calculated in step 104. Step 105 may involve comparing the parameter value to a reference measure which may be given as a threshold value or a range. If the comparison indicates a reduced performance, the processor unit 26 may output fault-data (fault) that indicates the reduced performance, for example in the form of a deviation between the parameter value and the reference measure, and, in some alternatives, indicate which component the reduced performance relates to.

In the example of FIG. 8, the noise values in signal Sₙₒᵢₛₑ are compared to a noise interval ΔSₙₒᵢₛₑ. A reduced performance may be identified based on a decision criterion. For example, the decision criterion may stipulate that a reduced performance is present whenever a current noise value is outside (deviates from) the noise interval ΔSₙₒᵢₛₑ. As seen, the noise signal Sₙₒᵢₛₑ is after time t₂ outside the interval ΔSₙₒᵢₛₑ. When time t₂ is registered the reduced performance may be determined. Optionally, the decision criterion may stipulate that a reduced performance is present whenever the noise values in signal Sₙₒᵢₛₑ are outside the interval ΔSₙₒᵢₛₑ for a given number of iterations of steps 101-106 (which may be equivalent to a given time period). In one embodiment, the reduced performance may be identified if a predetermined amount of the noise values (parameter values) received within a given number of interations are outside the interval ΔSₙₒᵢₛₑ. Suitable values for the predetermined amount and the given number of iterations may be empirically determined. By using such a decision criterion it is possible to suppress any remaining influence from touches on the parameter values.

In one embodiment, a current parameter value is compared with a previously calculated parameter value, which may e.g. be a reference value obtained by measurements performed in a final assembly step of the apparatus, such as the above-mentioned reference signal. It is also possible to compare the current parameter value with a time average of previously calculated parameter values, where the time average is determined for a certain period of time (number of iterations of steps 101-106) prior the retrieval of the current parameter value. Moreover, as indicated above, the comparison may be made with respect to a certain interval.

In one embodiment, the threshold or interval is predefined and retrieved by the processor unit 26 from the memory unit 27. If the parameter value represents SNR, the threshold/interval may be set based on the weakest touches (attenuations) to be detected in the signal S. Specifically, the weakest touches define a detection limit (a minimum attenuation), which may be given as a percentage (i.e. the minimum detectable percentage of change in the signal). In order to acheive the detection limit, the SNR of the signal S should be at least of the same magnitude as this percentage. Thus, the threshold/interval may be set in proportion to the detection limit.

Generally, the treshold/interval to be used depends on e.g. the various types of components in the apparatus and on any amplification used for generating the signal S. The treshold/interval may be empirically determined for the specific apparatus. Empirically determining the threshold/interval may include measuring the temporal variability when certain components are known to be defect.

If the temporal variability is monitored for a signal S that represents an aggregation of sub-signals S_{L1}-S_{Ln}, the processor unit 26 may be configured to establish that at least some part of the apparatus 1 has a reduced performance and generate a signal calling for a certain operator-activity. The operator activity may include cleaning of the touch surface or maintenance of the apparatus if the cleaning does not render an improved performance. In this context, improved performance may mean that the decision criterion of step 105 no longer is fulfilled, e.g. that the parameter values no longer exceed the threshold or that they return to within the interval.

The reduced performance may, as mentioned, also be identified for each of a number of sub-signals S_{L1}-S_{Ln}. This corresponds to determining the temporal variability for a set of detection lines L1-Ln, in which case it is possible to more specifically determine the cause of the reduced performance.

For example, if all detection lines from a specific light emitter to a number of light detectors indicate (via the associated sub-signals) a reduced performance, the processor unit 26 may establish that the specific light emitter has a reduced performance. This conclusion may be further supported if detection lines from other light emitters to the same light detectors do not indicate (via the associated sub-signals) a reduced performance.

In a similar manner, if all detection lines from a number of light emitters to a specific light detector indicate (via the associated sub-signals) a reduced performance, the processor unit 26 may establish that the specific light detector has a reduced performance. This conclusion may be further supported if detection lines from the same light emitters to other light detectors do not indicate (via the associated sub-signals) a reduced performance.

When a specific light emitter with reduced performance is detected, light emitted from this emitter may be discarded when determining the location A1, which typically means that any sub-signal related to the light emitter is not taken into account. In a similar manner, sub-signals related to a light detector with reduced performance may be ignored.

Optionally, the energy of light emitted from a light emitter with reduced performance may be increased, instead of ignoring sub-signals from that emitter. Also, when determining the location, it is possible to determine specific values of one or more touch detection thresholds (also denoted “touch thresholds” herein) to be applied for identifying the touches in the sub-signals.

To facilitate efficient maintenance of the apparatus, the processor unit 26 may be configured to generate a signal indicative of which light emitter or light detector has a reduced performance.

Returning to FIG. 6, in step 106 the location A1 is determined, which may be done when the object 3 touches the touch surface 4 and attenuates the light. Numerous standard techniques may be used for this purpose, using the signal/sub-signals as input, such as triangulation based techniques and tomography based techniques. Examples of tomographic algorithms designed for use in touch determination are found in WO2010/006883 and WO2009/077962, as well as in PCT/SE2010/051103 filed on Oct. 13, 2010 and U.S. 61/282,973 filed on May 3, 2010, all of which are incorporated herein by reference.

Depending on location determination technique and type of illumination arrangement and light detection arrangement, the task of determining the location may sometimes be overdetermined in the sense that not all sub-signals must be used. Also, instead of always ignoring sub-signals related to a defect component, it may be determined that these sub-signals shall be taken into account if they exhibit signal levels (values) that exceed a specific touch detection threshold.

An example of such a touch detection threshold is illustrated in FIG. 9 which shows the sub-signal (transmission signal) S_{Ln} when all components of the apparatus are operating properly, in combination with a touch threshold level THR₁ to be used for determining locations (like A1). The following examples are applicable to both sub-signals S_{L1}-S_{Ln} and the aggregated signal S. In the latter case, the signal profile of FIG. 9 may represent e.g. the energy of light in a certain area element (pixel) on the touch surface 4. In principle, when the signal S is below the touch threshold level THR₁, the processor unit 26 may determine that an object is touching the panel. For example, the decrease in section S_{A} of the sub-signal S_{Ln} is typical for a gentle (weak) touch, while the decrease in section S_{B} is typical for an average touch on the touch surface. As seen, the touch threshold level THR₁ is set relatively close to a time average of the signal S, which is possible since the signal S is quite constant over time.

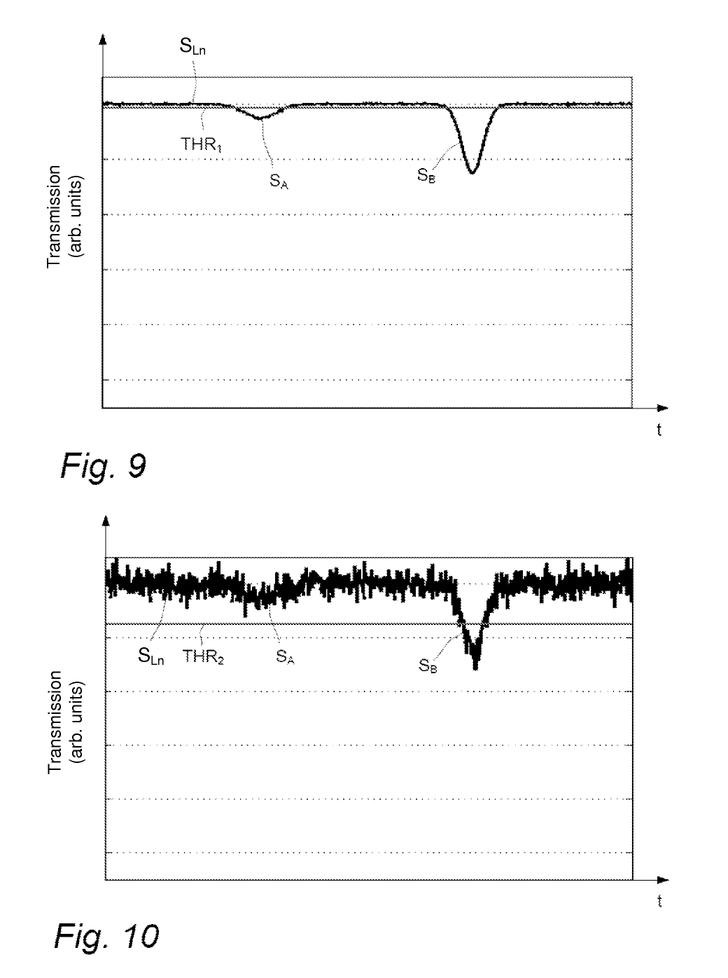

FIG. 10 illustrates the sub-signal (transmission signal) S_{Ln} when there is a reduced performance of a light detector in the touch-sensitive apparatus. Compared to FIG. 9, the sub-signal S_{Ln} varies significantly and another touch threshold level THR₂ may be used for preventing the apparatus to interpret signal variations caused by defect components as touches. In this case, the apparatus may however fail in detecting section S_{A} of the sub-signal S_{Ln}, i.e. the attenuation caused by the gentle touch, since the touch threshold level THR₂ has been set to a value relatively far from the time average of the sub-signal S_{Ln}. However, the average touch indicated by section S_{B} may be detected since it falls below the touch threshold level THR₂.

In order to adapt to a gradually reduced performance, the touch threshold level may be gradually changed over the time such that signal variations due to a reduced performance may not be interpreted as a touch. Standard techniques may be adopted to gradually change the touch threshold level. Touch threshold levels may be similarly used, and gradually changed, for the aggregated signal S.

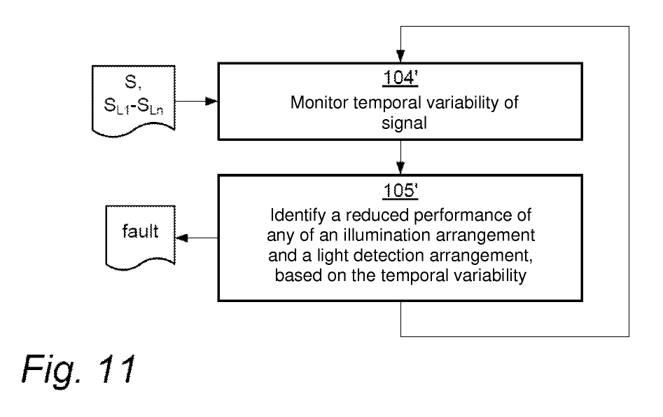

With reference to FIG. 11, a step 104′ of monitoring the temporal variability and a step 105′ of determining a reduced performance may be implemented as a stand-alone process for detecting a reduced performance. These steps correspond to steps 104, 105 of the combined method in FIG. 4. The input signals S, S_{L1}-S_{Ln} may be provided by a touch-sensitive apparatus while the fault data may be sent to the same touch-sensitive apparatus. The fault data may indicate the reduced performance. If sub-signals are used as input or are derived from the signal S, the fault data may indicate a defect emitter or detector or a defect detection line. For example, if the touch-sensitive apparatus is a scanning apparatus, the “defect” detection line may result from a malfunctioning light incoupling element or light outcoupling element for the detection line. Irrespective of the type of touch-sensitive apparatus, the process in FIG. 11 provides add-on functionality to existing methods and apparatuses for determining a location on a touch surface. It is realized that the process in FIG. 11 may be implemented on a separate device adaped for connection to the touch-sensitive apparatus. In a variant, the process/separate device also generates the signal S or sub-signals S_{L1}-S_{Ln}.

Software instructions, i.e. a computer program code for carrying out embodiments of the described methods may for development convenience be written in a high-level programming language such as Java, C, and/or C++ but also in other programming languages, such as, but not limited to, interpreted languages. The software instructions may also be written in assembly language or even micro-code to enhance performance and/or memory usage. Accordingly, a computer-readable medium (e.g. 27 in FIG. 2) may store processing (software) instructions that, when executed by the processor unit 26, perform the above-described methods.

It will be further appreciated that the functionality of any or all of the functional steps performed by the device may also be implemented using discrete hardware components, one or more application specific integrated circuits, or a programmed digital signal processor or microcontroller. For example, the parameter values may be directly obtained as output from an analog or digital circuit or a combination of discrete electronic components.

As indicated, the processor unit performs a repetitive operation for determining the reduced performance/interaction. Moreover, the respective iteration may be continuously performed regardless if an object interacts with the touch surface. Also, operations of the processor unit may be performed in a different order than described, may be combined and may be divided into sub-operations. Also, as the skilled person realizes, the processor unit may comprise one or more data processors which each performs one or more of the described processing operations.

Although the above disclosure has been focused on enabling concurrent detection of reduced performance and touch determination, it is to be understood that the presented techniques for detection of reduced performance may also be used separate from touch determination, e.g. in time periods when no touch is present on the touch surface.

1. A device for processing data from a touch-sensitive apparatus, said touch-sensitive apparatus comprising a light transmissive panel, an illumination arrangement for introducing light into the panel, and a light detection arrangement for receiving the light propagating in the panel and for measuring the energy of the received light, said device comprising a processor unit configured to:
obtain a signal comprising a time series of signal values that represent the energy of the light received by the light detection arrangement;
calculate a parameter value representing a temporal variability of the signal values in the signal; and
identify, based on the parameter value, a reduced performance of any of the illumination arrangement and the light detection arrangement.

2. The device of claim 1, wherein the parameter value is calculated to represent one of an absolute noise level and a signal-to-noise ratio of the signal.

3. The device of claim 1, wherein the parameter value is calculated to represent the temporal variability within a time window in the signal.

4. The device of claim 1, wherein the processor unit is further configured to high-pass filter the signal, wherein the parameter value is calculated based on the high-pass filtered signal.

5. The device of claim 1, wherein the processor unit is configured to, for identifying the reduced performance, compare the parameter value to a reference measure, wherein the reference measure is one of a range and a threshold.

6. The device of claim 5, wherein the reference measure is predefined.

7. The device of claim 5, wherein the reference measure is determined based on preceding signal values in the signal.

8. (canceled)

9. (canceled)

10. The device of claim 1, wherein the processor unit is configured to identify the reduced performance as a function of a noise characteristic of the time series of signal values.

11. (canceled)

12. (canceled)

13. The device of claim 1, wherein the processor unit is configured to, if the reduced performance is identified, generate a signal for increasing the energy of light emitted from a certain emitter of the illumination arrangement, the certain emitter being associated with the reduced performance.

14. The device of claim 1, wherein the processor unit is configured to determine, when an object touches the touch surface and thereby attenuates the light propagating in the panel, a location of the object on the touch surface as a function of the signal.

15. The device of claim 14, wherein the processor unit is configured to, if the reduced performance is identified, disregard light emitted from a certain emitter of the illumination arrangement when determining the location, the certain emitter being associated with the reduced performance.

16. The device of claim 14, wherein the processor unit is configured to, if the reduced performance is identified, disregard light detected by a certain detector of the light detection arrangement when determining the location, the certain detector being associated with the reduced performance.

17. The device of claim 14, wherein the processor unit is configured to, when determining the location, compare the signal values in the signal to at least one touch threshold value and wherein the processor unit is configured to update said at least one touch threshold value as a function of the reduced performance.

18. The device of claim 17, wherein the processor unit is configured to calculate the parameter value for each of a set of sub-signals in the signal, wherein each sub-signal corresponds to a respective detection line extending between an emitter of the illumination arrangement and a detector of the light detection arrangement.

19. The device of claim 18, wherein the processor unit is configured to, if the reduced performance is identified for a certain detection line, disregard signal values associated with the certain detection line when determining the location.

20. The device of claim 18, wherein the processor unit is configured to compare the signal values of each sub-signal to a respective touch threshold value, and wherein the processor unit is configured to update the touch threshold values as a function of the reduced performance.

21. The device of claim 18, wherein the processor unit is configured to determine which of an emitter of the illumination arrangement and a detector of the light detection arrangement that causes the reduced performance, as a function of the temporal variability of the signal values in each sub-signal.

22. (canceled)

23. An apparatus for determining a location of at least one object on a touch surface, the apparatus comprising:
a light transmissive panel defining the touch surface and an opposite surface;
an illumination arrangement configured to introduce light into the panel for propagation by internal reflection between the touch surface and the opposite surface;
a light detection arrangement configured to receive the light propagating in the panel and measure the energy of the received light; and
a device as set forth in claim 1.

24. (canceled)

25. A method for processing data from a touch-sensitive apparatus, said touch-sensitive apparatus comprising a light transmissive panel, an illumination arrangement for introducing light into the panel, a light detection arrangement for receiving the light propagating in the panel and measuring the energy of the received light, said method comprising:
obtaining a signal comprising a time series of signal values that represent the energy of the light received by the light detection arrangement;
calculating a parameter value representing a temporal variability of the signal values in the signal; and
identifying, based on the parameter value, a reduced performance of any of the illumination arrangement and the light detection arrangement.

26. A computer-readable medium storing processing instructions that, when executed by a processor, performs the method according to claim 25.
